(19) United States
(12) Patent Application Publication
(10) Pub. No.: US 2008/0235747 A1
(43) Pub. Date: Sep. 25, 2008

(54) METHOD AND APPARATUS FOR SHARING DIGITAL CONTENTS AND SYSTEM FOR SHARING DIGITAL CONTENTS BY USING THE METHOD

(75) Inventor: Hyung-tak CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/970,111

(22) Filed: Jan. 7, 2008

(30) Foreign Application Priority Data
Mar. 22, 2007 (KR) 10-2007-0028237

(51) Int. Cl. H04N 7/173

(52) U.S. Cl. 725/114

(57) ABSTRACT

A method and apparatus for sharing digital content and a system for sharing digital content are provided. A multimedia device, such as an Internet Protocol Television (IPTV), as the apparatus for sharing digital content, includes a decoder for decoding digital content data; a Digital Signal Processor (DSP) for encoding the digital content data decoded by the decoder to have a data format which a remote device supports; and a network interface for transmitting the digital content data re-encoded by the DSP to the remote device. In the present invention, once a user subscribes for a content providing service for the IPTV, the user is able to watch digital content of the IPTV in a remote place by using the mobile phone, or the like without separately subscribing for a service for the mobile phone.

### CROSS-REFERENCE TO RELATED PATENT APPLICATION

This application claims the benefit of Korean Patent Application No. 10-2007-0028237, filed on Mar. 22, 2007, in the Korean Intellectual Property Office, the disclosures of which is incorporated herein in its entirety by reference.

### BACKGROUND OF THE INVENTION

1. Field of the Invention

Methods and apparatuses consistent with the present invention relate to a multimedia device (e.g., digital television (TV)), more particularly, a method and an apparatus for sharing digital content using a videophone function of an Internet Protocol (IP) TV.

2. Description of the Related Art

Due to recent advances in high-speed Internet technology, transmission rates of data transmitted via communication networks is greatly increasing. This high-speed Internet technology has been combined with digital TV technology, whereby Internet Protocol Television (IPTV), a new concept in TV service, has appeared. Also, videophone technology is expected to combine with the IPTV. That is, high-speed Internet, Internet telephone, and Internet broadcasting will combine in the near future, whereby a Triple Play Service (TPS) may be realized.

If the user uses the IPTV in order to search the Internet then the IPTV may operate as a personal computer (PC) for Internet searching.

If the user uses the IPTV in order to watch a broadcast program, the user may be able to watch the broadcast program in real-time and also when the user wants, using a Video on Demand (VOD) function of the IPTV. Since the IPTV also provides a personal video recorder (PVR) function, the user can store a desired broadcast program within an internal memory of the IPTV and reproduce and watch the broadcast program when desired.

Also, the user may be able to use the IPTV as a videophone. If the IPTV supports a Voice over Internet Protocol (VoIP), the user may record an image and a voice of the user using a microphone and a camera built into the IPTV and then the IPTV may transmit audio/video signals corresponding to the recorded image and voice to others via a network.

However, users expect various other functions from the IPTV. For example, the user may want to use the IPTV which is inside a house while the user is outside the house. That is, the user may want to control the IPTV from a remote place, such as turning on/off the IPTV, using the videophone function of the IPTV, to record a desired broadcast program using the PVR function of the IPTV, or to watch a broadcast program currently being transmitted to the IPTV or that is stored in the memory of the IPTV using a mobile phone. However, it is difficult to satisfy the user expectations with a conventional IPTV technology.

### SUMMARY OF THE INVENTION

The present invention provides a method and an apparatus for controlling a multimedia device (e.g., a digital television (TV)), which receives multimedia signals, using a remote device connected to the digital TV via a network or by sharing digital content of the digital TV with the remote device, and a Triple Play Service (TPS) system using the method.

According to an aspect of the present invention, there is provided a digital TV for sharing digital content, the digital TV including: a decoder to decode digital content data; an encoder to encode digital content data decoded by the decoder to have a data format which a remote device supports; and a network interface to transmit digital content data re-encoded by the encoder to the remote device.

According to another aspect of the present invention, there is provided a remote device for sharing digital content, the remote device including: a network interface that supports a videophone protocol; an audio/video (A/V) decoder to decode digital content received from a digital TV via the network interface; and an A/V output unit to output digital content decoded by the A/V decoder.

According to another aspect of the present invention, there is provided a remote device having a videophone function, the remote device including: a network interface that supports a videophone protocol; a user input unit by which the user can input a command to control a digital TV; and a control unit which controls the digital TV located in a remote place via the network interface according to an input command received from the user input unit.

According to another aspect of the present invention, there is provided a system for sharing digital content, the system including: a remote device that supports a videophone protocol; a digital TV to transmit digital content data to the remote device according to the videophone protocol; and a network to electronically connect the remote device with the digital TV.

According to another aspect of the present invention, there is provided a method for sharing digital content using a remote device connected with a digital TV via a network, the method including the operations of: accessing the digital TV; selecting digital content when the digital TV is accessed; and receiving selected digital content from the digital TV.

According to another aspect of the present invention, there is provided a method for sharing digital content using a digital TV connected with a remote device via a network, the method comprising: determining whether the remote device supports a format of digital content data requested by the remote device to be transmitted; decoding the digital content data, when the remote device does not support the format of the requested digital content data; re-encoding the decoded digital content data; and transmitting the original digital content or re-encoded digital content data to the remote device.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a Triple Play Service (TPS) system according to an exemplary embodiment of the present invention;

FIG. 2 is a block diagram of an Internet Protocol Television (IPTV) according to an exemplary embodiment of the present invention;

FIG. 3 is a block diagram of an IPTV according to another exemplary embodiment of the present invention;

FIG. 4 is a block diagram illustrating a formation of remote devices according to an exemplary embodiment of the present invention; and

FIG. 5 is a flowchart of a method for sharing digital content, according to an exemplary embodiment of the present invention.

### DETAILED DESCRIPTION OF THE EXEMPLARY EMBODIMENTS OF THE INVENTION

The present invention will now be described more fully with reference to the accompanying drawings, in which exemplary embodiments of the invention are shown.

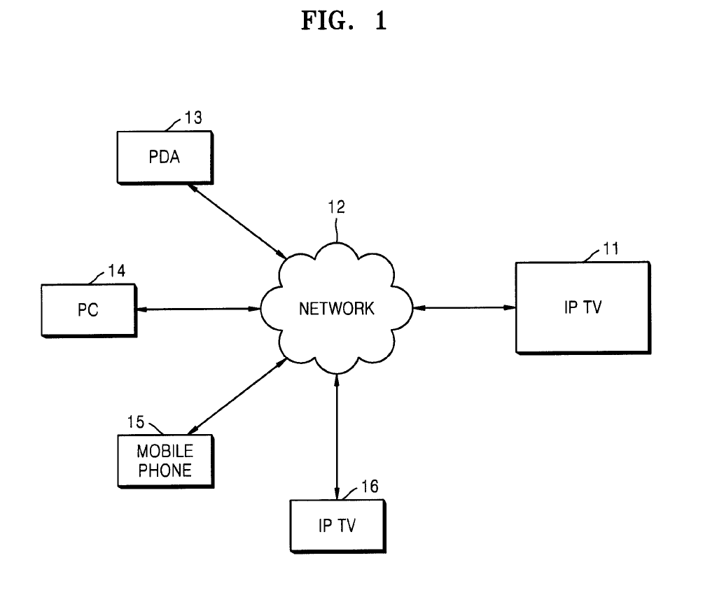

FIG. 1 illustrates a Triple Play Service (TPS) system according to an exemplary embodiment of the present invention. The TPS system includes an Internet Protocol Television (IPTV) 11, remote devices 13 through 16, and a network 12 which electronically connects an IPTV with a remote device via wired/wireless channels.

The IPTV 11 according to an exemplary embodiment of the present invention, is not only a common IPTV but also an Internet TV, a personal computer (PC) having functions of an IPTV and a conventional digital TV having a set-top box to perform functions of the IPTV.

Examples of the remote device include a mobile phone, a PC, a Personal Digital Assistant (PDA), a Digital Multimedia Broadcasting (DMB) and the IPTV.

The above-mentioned IPTV and remote devices are also required to support a videophone protocol such as a Voice over Internet Protocol (VoIP) or a Video and Voice over Internet Protocol (V2oIP).

A network includes all kinds of networks, such as the Internet and a Local Area Network (LAN), which can support the TPS system.

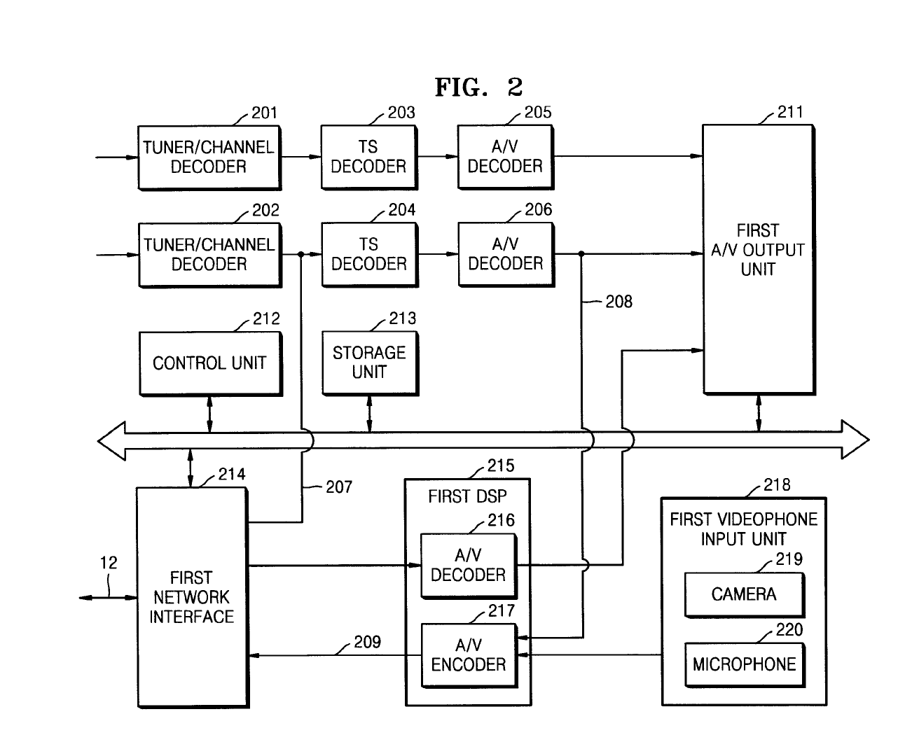

FIG. 2 is a block diagram of the IPTV 11 according to an exemplary embodiment of the present invention.

The IPTV 11 illustrated in FIG. 2 receives digital content data in the form of a terrestrial broadcast signal or a cable broadcast signal.

Tuner/channel decoders 201 and 202 filter and separate a transport stream (TS) of a channel selected by a viewer from a digital broadcast signal received by the IPTV 11 and then perform demodulation.

TS decoders 203 and 204 demultiplex and divide the TS into TS data, for example, video data, audio data, additional information data, and the like.

Audio/video (A/V) decoders 205 and 206 decode video data and audio data demultiplexed by the TS decoders 203 and 204. Examples of the A/V decoders 205 and 206 include an Advanced Video Coding (AVC) decoder, a Bit Sliced Arithmetic Coding (BSAC) decoder, a Joint Photographic Experts Group (JPEG) decoder, and the like. The AVC decoder decompresses compressed moving picture data and the JPEG decoder decompresses compressed still image. The BSAC decoder decompresses compressed audio data.

A format converter (not shown) performs signal processing to improve clearness of the decoded video data or scales video data so as to adjust the video data to the size of a display in a first A/V output unit.

A display control unit (not shown) is a module for performing overall functions for displaying image on a display, such as displaying data information or a caption on the display. In the case where decoded data is an analogue signal, the display control unit converts the analogue signal and then displays the converted signal on the display.

An A/V output unit 211 includes a display and a speaker and outputs decoded A/V data to a user.

A first control unit 212 controls all components of an IPTV according to a user's command. The user's command is delivered to the first control unit 212 via remote devices 13 through 16 or a remote controller (not shown).

A storage unit 213 is able to store the digital content data received by the IPTV 11.

A first videophone input unit 218 includes a camera 219 and a microphone 220 and supports a videophone protocol of the IPTV 11.

A first Digital Signal Processor (DSP) 215 includes an A/V decoder 216 and an A/V encoder 217. The A/V decoder 216 and the A/V encoder 217 may include one or more A/V decoders and one or more A/V encoders, respectively. The first DSP 215 encodes an A/V signal recorded by the camera 219 and the microphone 220 included in the first videophone input unit 218.

Furthermore the first DSP 215 encodes TS data 208 decoded by the A/V decoder 206, into A/V data having a format which the remote device can reproduce. Accordingly, even if the remote devices 13 through 16 are not able to reproduce the TS data 208, digital content including content identical to the TS data 208 can be reproduced in the remote devices 13 through 16. For example, the TS data 208 decoded by the A/V decoder 206 is encoded again by the A/V encoder 217 according to one of Moving Picture Experts Group (MPEG) 4, H.263 and H.264, which are data format standards that the remote device 13 through 16 support. “TMS320DM642 DSP” of Texas Instruments Inc. is an example of a commonly used DSP that can perform this function.

A first network interface 214 performs interfacing between the IPTV 11 and the network 12. The first network interface 214 transmits digital content 207 of a TS format received from the tuner/channel decoder 202 or digital content 209 encoded by the first DSP 215 to the remote devices 13 through 16 via the network 12.

Accordingly the first network interface 214 supports Session Initiation Protocol (SIP), H.323, Transfer Control Protocol (TCP), User Datagram Protocol (UDP), Internet Protocol (IP), Real-time Transport Protocol (RTP), Real Time Streaming Protocol (RTSP), Real Time Control Protocol (RTCP), and the like so that the IPTV 11 can perform a videophone function.

The first network interface 214 performs input and output functions when the IPTV 11 performs the videophone function, when it operates as a live-TV (that is, a multicast function), and when it performs a Video on Demand (VOD) function (that is, a unicast function). Other than when the IPTV 11 performs the aforementioned functions, the first network interface 214 performs only an output function.

The digital content processed by the TS decoder 204 is decoded by the A/V decoder 206 and then re-encoded by the A/V encoder 217 in the first DSP 215 according to the current exemplary embodiment. However, the digital content processed by the TS decoder 204 may be decoded by the A/V encoder 216 in the first DSP 215 according to another exemplary embodiment of the present invention.

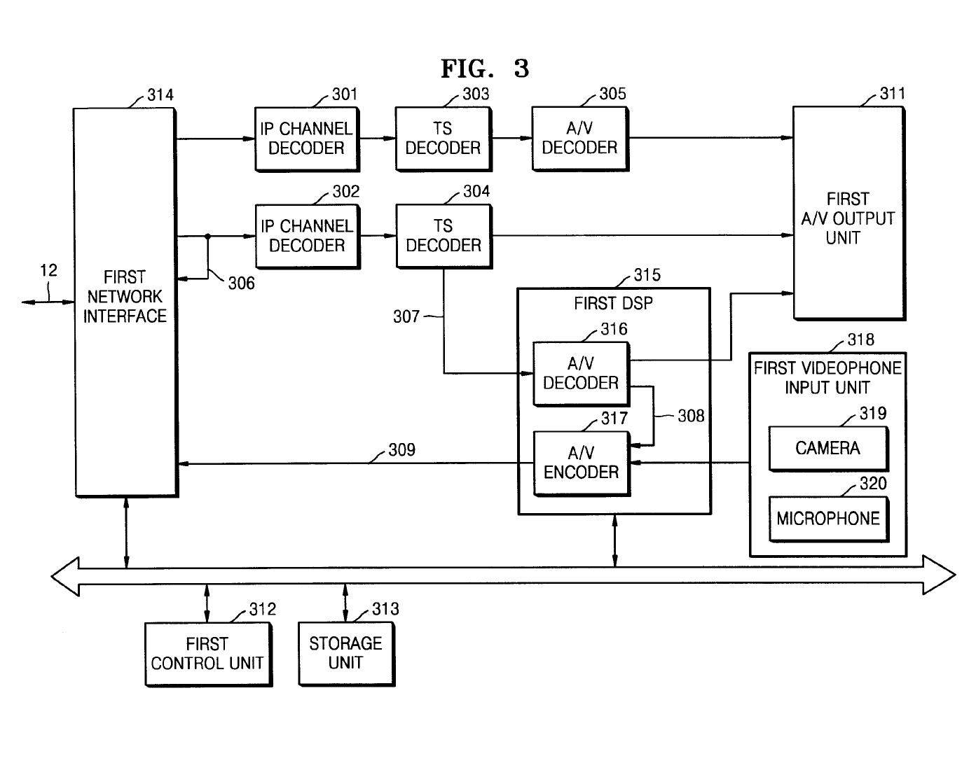

FIG. 3 is a block diagram of the IPTV 11 according to another exemplary embodiment of the present invention.

The details already explained in relation to FIG. 2 are omitted for a concise explanation.

The IPTV 11 illustrated in FIG. 3 receives digital content by a live-TV method or a VOD method.

Thus, a first network interface 314 receives the digital content by one of a multicast method and a unicast method from a content server (not shown) connected via a network.

When the IPTV 11 operates as a personal video recorder (PVR), the digital content received by the first network interface 314 is directly transmitted to a storage unit 313 and stored therein.

If a remote device is able to reproduce TS, digital content 306 having a TS format, which are received from the first network interface 314, can be transmitted directly to the remote device via the first network interface 314.

However, if the remote device is not able to reproduce TS, digital content received by the first network interface 314 pass through an IP channel decoder 302, a TS decoder 304, an A/V decoder 316 within a first DSP 315, and an A/V decoder 317 within the first DSP 315 to become A/V data 309 having a format which the remote device supports and is then transmitted to the remote device through the first network interface 314.

The IP channel decoder 302 outputs digital content of a selected channel from among a plurality of received channels, having the TS format.

As described above, the A/V decoder 317 within the first DSP 315 is required to encode decoded digital content 308 into A/V data having a format which a remote device can reproduce.

Digital content 307 processed by the TS decoder 304 are decoded by the A/V decoder 316 within the first DSP 315, according to the current exemplary embodiment. However, the digital content 307 processed by the TS decoder 304 may be decoded by another A/V decoder 305, according to another exemplary embodiment of the present invention.

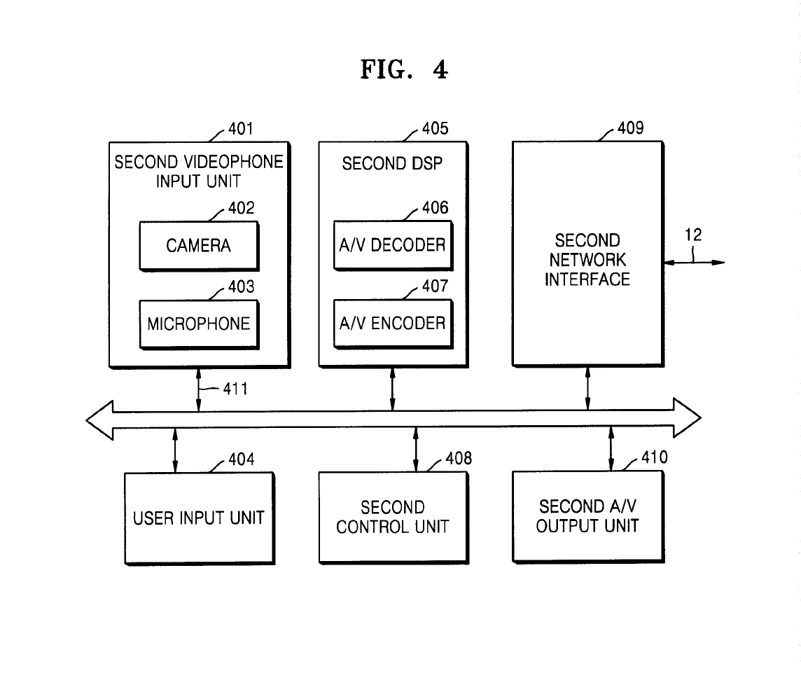

FIG. 4 is a block diagram illustrating a formation of the remote devices 13 through 16 according to an exemplary embodiment of the present invention.

The remote devices according to the current exemplary embodiment of the present invention includes a second videophone input unit 401, a user input unit 404, a second DSP 405, a second control unit 408, a second network interface 409, and a second A/V output unit 410.

The second videophone input unit 401 includes a camera 402 and a microphone 403 in order to enable the remote device to operate as a videophone.

The second network interface 409 handles interfacing between the remote device and the network 12. That is, the second network interface 409 transmits videophone data 411 encoded by an A/V encoder 407, to the IPTV 11 via the network 12. The second network interface 409 receives digital content from the IPTV 11 via the network 12 using a videophone function. Accordingly the second network interface 409 has to be capable of supporting SIP, H.323, TCP, UDP, IP, RTP, RTSP, RTCP, and the like so that the remote device can be operated as the videophone.

The second DSP 405 includes an A/V decoder 406 and an A/V encoder 407. The A/V encoder 407 included in the second DSP 405 encodes an A/V signal captured and recorded by the camera 402 and the microphone 403 included in the second videophone input unit 401.

The A/V decoder 406 within the second DSP 405 decodes the digital content received from the IPTV 11 and transmits the decoded digital content to the second A/V output unit 410.

The second A/V output unit 410 includes a display and a speaker and outputs A/V data decoded by the A/V decoder 406.

The user input unit 404 is an input unit to deliver a user's command to the second control unit 408 so that the user can control the IPTV 11 located in a remote place. That is, the user manipulates the user input unit 404 of the remote device so as to connect the remote device with the IPTV 11 in the remote place and go through an authentication procedure. The user may also be able to select digital content that the user wants to receive from the connected IPTV 11 using the user input unit 404.

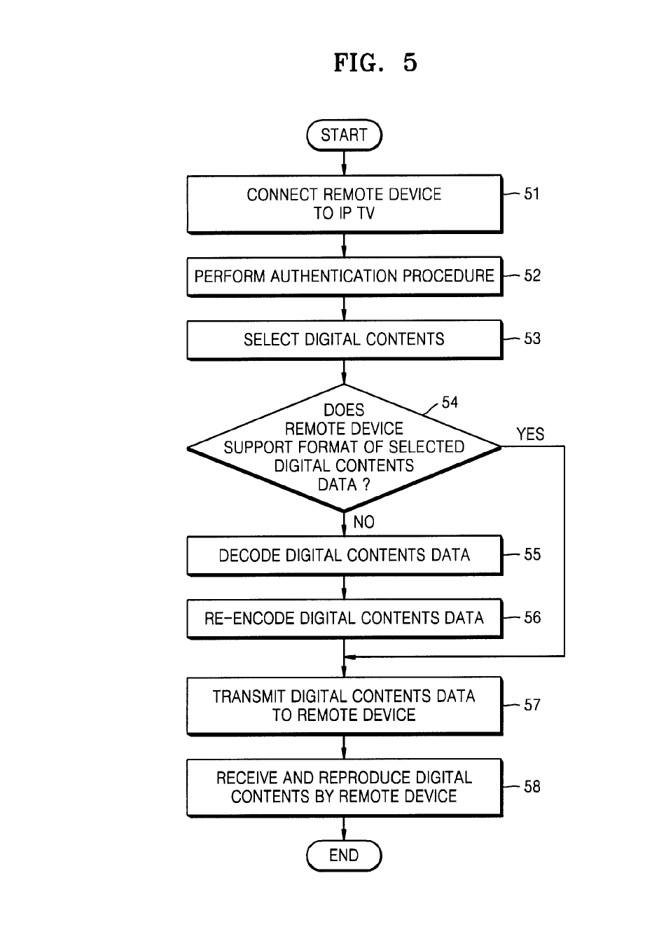

FIG. 5 is a flowchart of a method for sharing digital content, according to an exemplary embodiment of the present invention.

In operation 51, a user tries to electronically connect the remote devices 13 though 16 with the IPTV 11 located in a remote place via the network 12.

In operation 52, an authentication procedure for the remote device is performed. Once the remote device is electronically connected with the IPTV 11, the first control units 212 and 312 of the IPTV 11 perform the authentication procedure to determine whether the connected remote device has authentication to be connected with the IPTV 11. For this authentication procedure, an identification (ID)/password set or an authentication key may be used.

In operation 53, the user selects digital content to be transmitted from the IPTV 11 to the remote device. The user may select digital content currently being reproduced by the first A/V output units 211 and 311 of the IPTV 11 or digital content stored in storage units 213 and 313, and then may request the IPTV 11 to transmit the selected digital content.

In operation 54, the first control units 212 and 312 of the IPTV 11 determine whether the remote device can support a format of digital content data selected in operation 53. The reason for performing operation 53 is that there are remote devices can not support some formats among various formats that digital content may have. For example, if the remote device does not have a digital TV function, the remote device is not able to reproduce digital broadcast data, e.g., an MPEG 2 encoded TS, received from the IPTV 11. Thus, the first control units 212 and 312 of the IPTV have to predetermine whether digital content data requested by the remote device can be reproduced in the remote device.

In the case where the remote device supports a format of digital content data selected by the user, the IPTV 11 transmits the digital content data directly to the remote device (operation 57), omitting operations 55 and 56.

In operation 55, the selected digital content data is decoded. In the case where the remote device can not support the format of the selected digital content data, the IPTV 11 decodes the selected digital content data. For example, the IPTV 11 demultiplexes the TS and then performs decoding according to the MPEG 2 standard.

In operation 56, the decoded digital content are re-encoded. The decoded digital content in operation 55 are re-encoded to have an A/V data format which the remote device supports. For example, in the case where the remote device supports one of data standards MPEG 4, H.263 and H.264, the decoded digital content are encoded according to one of the data standards MPEG 4, H.263 and H.264.

In operation 57, the digital content are transmitted to the remote device. In this operation the IPTV 11 processes the original digital content selected in operation 53 or the re-encoded digital content in operation 56 into an IP packet and then transmits the IP packet to the remote device via the network 12. Here, the digital content being transmitted may be a moving picture or a still image obtained by capturing a frame from the moving picture.

In operation 58, the remote device receives and reproduces the digital content. The remote device receives the digital content transmitted in operation 57 and then decodes and outputs the digital content via the second A/V output unit 410.

In this way, the user is able to watch or check the digital content currently being reproduced by the IPTV 11, via the second A/V output unit 410. Also, the user may watch digital content stored in the storage unit 313 through a VOD method.

In a conventional method, when a user wanted to watch pay digital content using a portable apparatus e.g., a mobile phone, the user had to separately subscribe for a content providing service. In the present invention, once a user subscribed for a content providing service for the IPTV, the user is able to watch digital content of the IPTV in a remote place using the mobile phone, or the like without separately subscribing for a service for the mobile phone. Parents working outside the home may monitor TV programs that their children watch. Also, a user outside the home may record a desired TV program using the mobile phone, or the like.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, hard disk drives, floppy disks, optical data storage devices. The computer readable recording medium can also be distributed over network coupled computer systems so that the computer readable code is stored and executed in a distributed fashion.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A multimedia device for sharing digital content, the multimedia device comprising:
a decoder operable to decode digital content data;
an encoder which re-encodes the decoded digital content data into a data format which a remote device supports; and
a network interface which transmits the re-encoded digital content data to the remote device.

2. The multimedia device of claim 1, wherein the digital content data is received in a form of one of a terrestrial broadcast signal and a cable broadcast signal.

3. The multimedia device of claim 1, wherein the digital content data is received by the multimedia device in one of a multicast signal and a unicast signal via a network.

4. The multimedia device of claim 1, further comprising a storage unit which stores the digital content data.

5. The multimedia device of claim 4, wherein the decoded digital content data is stored in the storage unit.

6. The multimedia device of claim 4, wherein the storage unit is for supporting the multimedia device in performing a personal video recorder (PVR) function.

7. The multimedia device of claim 1, wherein the network interface supports a videophone protocol.

8. The multimedia device of claim 1, further comprising a control unit which authenticates the remote device.

9. The multimedia device of claim 1, wherein if the remote device supports a format of the digital content data, the network interface transmits the digital content data to the remote device without decoding.

10. A remote device for sharing digital content data, the remote device comprising:
a network interface supporting a videophone protocol;
an audio/video (A/V) decoder which decodes digital content data received from a multimedia device via the network interface; and
an A/V output unit which outputs the decoded digital content data.

11. The remote device of claim 10, further comprising a control unit which connects to the multimedia device and requests the digital content to be transmitted.

12. The remote device of claim 10, wherein the remote device is one of a mobile phone, a Personal Computer (PC), a Personal Digital Assistant (PDA), a Digital Multimedia Broadcasting (DMB), and a digital TV.

13. The remote device of claim 10, further comprising a user input unit which inputs a command to control the multimedia device.

14. The remote device of claim 10, further comprising a videophone input unit which performs a videophone function.

15. The remote device of claim 10, further comprising:
a user input unit which inputs a command to control the multimedia device; and
a control unit which controls the multimedia device via the network interface according to the input command.

16. A system for sharing digital content, the system comprising:
a remote device supporting a protocol;
a multimedia device transmitting digital content data to the remote device according to the protocol; and
a network connecting the remote device with the multimedia device.

17. The system of claim 16, wherein the system for sharing digital content supports a Triple Play Service (TPS).

18. The system of claim 16, wherein the multimedia device comprises an A/V encoder which encodes the digital content data to have a data format that the remote device supports.

19. A method for sharing digital content using a remote device connected to a multimedia device via a network, the method comprising:
accessing the multimedia device;
selecting digital content data when the multimedia device is accessed; and
receiving selected digital content data from the multimedia device.

20. The method of claim 19, further comprising:
decoding the received digital content data; and
outputting decoded digital content data.

21. A method for sharing digital content using a multimedia device connected with a remote device via a network, the method comprising:
determining whether the remote device supports a format of a requested digital content data;
if the remote device does not support the format of the requested digital content data:
decoding the digital content data;
re-encoding the decoded digital content data; and
transmitting the re-encoded digital content data to the remote device,
if the remote device does support the format of the requested digital content data, transmitting the original digital content data to the remote device.

22. The method of claim 21, further comprising authenticating the remote device to determine whether the remote device is authorized to connect to the multimedia device.

23. The method of claim 21, wherein the multimedia device and the remote device support a videophone protocol.

24. The method of claim 23, wherein the videophone protocol comprises at least one of a Session Initiation Protocol (SIP), a H.323 standard, a Transfer Control Protocol (TCP), a User Datagram Protocol (UDP), an Internet Protocol (IP), a Real-time Transport Protocol (RTP), a Real Time Streaming Protocol (RTSP), and a Real Time Control Protocol (RTCP).

25. The method of claim 23, wherein the re-encoding of the decoded digital content data comprises, encoding the decoded digital content data according to one standard of Moving Picture Experts Group (MPEG) 4, H.263 and H.264.
